(19) United States
(12) Patent Application Publication
(10) Pub. No.: US 2018/0290390 A1
(43) Pub. Date: Oct. 11, 2018

(54) FASTENING A PART TO AN OBJECT IN AN ADJUSTED POSITION

(71) Applicant: MultiMaterial-Welding AG, Stansstad (CH)

(72) Inventors: Joakim Kvist, Nidau (CH); Philipp Bernhard, Thun (CH); Martin Sigrist, Bern (CH); Laurent Torriani, Lamboing (CH); Mario Weiss, Diessbach bei Buren (CH); Hannes Merz, Olten (CH); Antonino Lanci, Bern (CH); Samuel Malzach, Evilard (CH); Nicholas Aldersley, Hebertshausen (DE)

(21) Appl. No.: 15/942,736

(22) Filed: Apr. 2, 2018

(30) Foreign Application Priority Data
Apr. 4, 2017 (CH) 00448/17

(51) Int. Cl. B29C 65/72; B29C 65/56; B29C 65/08; B29C 65/00

(52) U.S. Cl. CPC B29C 65/72; B29C 65/561; B29C 65/08; B29L 2001/00; B29C 66/30223; B29C 66/742; B29C 66/7392; B29C 66/472

(57) ABSTRACT

An adaptor for anchoring a second object with respect to a first object includes an anchoring part and an adjustment part. The anchoring part includes a distally facing anchoring surface and a proximally facing first control surface, and the adjustment part includes a distally facing second control surface positioned to abut against the first control surface. The anchoring part and the adjustment part define a common axis, and the first control surface or the second control surface or both is/are helical with respect to the axis, whereby a relative z position of the adjustment part with respect to the anchoring part is adjustable by rotating the adjustment part relative to the anchoring part around the axis while the second control surface abuts against the first control surface.

### BACKGROUND OF THE INVENTION

### Field of the Invention

The invention is in the fields of mechanical engineering and construction, especially mechanical construction, for example automotive engineering, aircraft construction, railway industry, shipbuilding, machine construction, toy construction, building industries, etc. In particular, it relates to a method of—mechanically—fastening objects to each other in a defined position.

### Description of Related Art

In the automotive, aviation and other industries, there has been a tendency to move away from steel-only constructions and to use lightweight material such as aluminum or magnesium metal sheets or polymers, such as carbon fiber reinforced polymers or glass fiber reinforced polymers or polymers without reinforcement, for example polyesters, polycarbonates, etc. instead.

The new materials cause new challenges in bonding elements of these materials—especially in bonding flattish object to another object. An example for this is the bonding of parts of polymer-based material to metal parts, such as metal sheets.

A particular challenge when bonding elements to each other is the compensation of tolerances. In such bonds, a precise definition of the elements with respect to each other, and often also of the position of the fastener may be required.

### SUMMARY OF THE INVENTION

Accordingly, it is an object of the present invention to provide a device and a method for bonding a second object to a first object, which makes a precise definition of a relative position of the first and second objects possible.

According to an aspect of the invention, an adaptor for anchoring a second object with respect to a first object is provided. The adaptor includes an anchoring part and an adjustment part. The anchoring part includes a distally facing anchoring surface and a proximally facing first control surface, and the adjustment part includes a distally facing second control surface positioned to abut against the first control surface. The anchoring part and the adjustment part define a common axis, and the first control surface or the second control surface or both is/are helical with respect to the axis, whereby a relative z position of the adjustment part with respect to the anchoring part is adjustable by rotating the adjustment part relative to the anchoring part around the axis while the second control surface abuts against the first control surface. The adaptor further includes an engagement structure for fixing the adjustment part relative to the anchoring part with respect to axial directions while the first and second control surfaces abut against each other.

If the first control surface and the second control surface are both helical, the helix angle of the control surfaces may be the same.

The anchoring part may include a solid thermoplastic material liquefiable by mechanical vibration at least on the anchoring surface. Thereby, it may be anchored relative to the first object if the first object includes a generally flat portion, for example a metal sheet portion, with an edge. Such edge may especially extend around an opening in the first object, relative to which the anchoring part is anchored. In embodiments a section of the flat portion of the first object may be bent away from an object plane, towards proximally.

Especially, the anchoring part may be configured to be anchored relative to the first object so that it is immovable relative to the first object and that a re-adjustment of the first object's position after anchoring is generally not possible. Anchoring may be an essentially irreversible process (in contrast to for example screwed connections or clipped connections or bayonet fixing connections or the like), so that for example once the anchoring was carried out, a removal of the anchoring part from the first object would require a removal or breakage of material that connects the anchoring part to the first object.

Anchoring of the anchoring part may according to a first group of embodiments include a positive-fit connection between the anchoring part and the first object, by means of thermoplastic material that has been made flowable and that has re-solidified to yield the positive fit connection.

Fastening of the anchoring part to the first object may then be carried out by a method that includes embedding the edge of the first object into thermoplastic material of the anchoring part. Anchoring the anchoring part with respect to the first object may then include the steps of:
bringing the edge in contact with the anchoring surface,
while the edge is in contact with the thermoplastic material, coupling mechanical vibration energy into the assembly (that includes the anchoring part and the first object; especially coupling the energy into the anchoring part) until a flow portion of the thermoplastic material due to friction heat generated between the edge and the thermoplastic material becomes flowable and flows around the edge to at least partially embed the edge in the thermoplastic material, and
stopping the mechanical vibration and causing the thermoplastic material to re-solidify, whereby the re-solidified thermoplastic material at least partially embedding the edge anchors the anchoring part in the first object.

Especially, the method of anchoring the anchoring part relative to the first object may be carried out substantially as described in PCT/EP2016/073422. A detailed description of this anchoring method as well as of considerations concerning the shape of the first object depending on the desired application and on parameters can be found in PCT/EP2016/073422.

In addition or as an alternative to a positive fit connection, the anchoring part may be configured to be secured to the first object by an integral joint, such as an adhesive connection. To this end, the anchoring part may be provided with the anchoring surface including structures for accommodating an adhesive, for example one or more pockets.

The engagement structure may, according to a first group of embodiments, include a first engagement element of the anchoring part and a second engagement element of the adjustment part, which first and second engagement elements engage with each other when the adjustment part part is placed relative to the anchoring part. In this, the first engagement element or the second engagement element may run helically with respect to the axis, with a same helix angle as the one control surface that is helical (as both control surfaces if both control surfaces are helical). For example, the first or second engagement element may include a for example radial engagement protrusion and the other engagement element may include a helically running structure undercut with respect to axial directions, wherein the radial protrusion engages behind the undercut.

In an example, the engagement structure include a plurality of prongs of one of the adjustment part and of the anchoring part, the prongs clasping the other one of the adjustment part and of the anchoring part. Such prongs may have an engagement protrusion of the above kind, engaging with an indentation (defining the undercut) of the other one of the parts. This indentation may be helical with respect to the axis, having the same helix angle as the control surface(s). As an alternative to an indentation, the respective part may have a helical ridge behind which the engagement protrusion may engage, wherein such ridge defines the undercut.

Especially, the adjustment part may include such prongs, and the anchoring part may have the indentation.

In embodiments, the engagement structure (for example the adjustment part) may include a pair of prongs. Alternatively, more than two but for example three, four or more prongs may be present.

Prongs for clasping the respective other part may have an inwardly tapered end. Thereby, if the adjustment part and the anchoring part may be clipped together with a simple approximately axial relative movement.

As an alternative to prongs, the engagement structure may include a connection by a fastener, such as a screw connection.

According to a first possibility, the fastener may be configured to engage with the adjustment part, whereas the anchoring part has an axially running through hole. The fastener, which may include a fastener head, may then be inserted from the distal side (from the ‘underside’) through the through hole and engage with the adjustment part.

In embodiments implementing this first possibility, the adjustment part may include an inner thread, and the fastener is a screw that can be inserted from the distal side through the through hole and engage with the inner thread.

Also, in embodiments implementing this first possibility, the first object may be such that the distal side of the anchoring part remains accessible, for example through an opening in the first object (along which opening the edge extends in embodiments in which the anchoring includes embedding the edge).

The adaptor may, in embodiments implementing the first possibility, include a sealing portion having a sealing lip that is attached to the anchoring part and is configured to be pressed against a full circumference along an uninterrupted line whereby the connection is sealed.

Especially, such sealing portion may be constituted by an initially separate sealing element that is placed and fastened in a sealing element receiving indentation of the anchoring part. Alternatively, the sealing portion may be one-piece with a main body of the anchoring and for example manufactured by two-component injection molding.

In embodiments in which the bore in the adjustment part, which bore includes the inner thread for the screw, is closed off towards proximally, the sealing element may also be arranged on one of the anchoring part and of the adjustment part to be pressed against a surface of the other one of the anchoring part and the adjustment part, along an uninterrupted line encompassing the screw.

According to a second possibility, the fastener may be configured to engage with the anchoring part, whereas the adjustment part has an axially running through hole. The fastener can be inserted from the proximal (“upper”) side.

Also in embodiments implementing the second possibility, the fastener may be a screw. Then, the anchoring part will include an inner thread.

Further, also embodiments of this second possibility may include a sealing portion of the discussed kind. In addition or as an alternative, the anchoring part may have an extension portion protruding distally from a plane defined by the anchoring surface, wherein the inner thread extends into an interior of the extension portion. Such extension portion may have a closed distal end, whereby the inner thread extends into a blind hole distally closed off by the distal end. This approach also provides a sealing effect, because given a sealed attachment of the anchoring part to the first object there is no path between the proximal and distal sides of the first object with the anchoring part anchored relative thereto even if the first object has an opening at the location where the anchoring part is attached. For example, the extension portion may protrude into such opening and extend through it.

The anchoring part and/or the adjustment part may essentially be of a thermoplastic material. Thermoplastic parts can be, depending on their shape, manufactured by casting methods, such as injection molding. Also, if the anchoring part is of thermoplastic material at least near the anchoring surface, it is suitable of being anchored by the method mentioned hereinbefore.

If the adjustment part/the anchoring part is of a thermoplastic material or other plastic material, the structure with which the fastener engages—for example the inner thread—in accordance with the first or second possibility, respectively, may be formed by this plastic material. As an alternative, the adjustment part/anchoring part may include an insert element of a different material, for example of metal or of a mechanically stronger plastic, which insert element includes the inner thread.

The structure with which the fastener engages in the embodiments according to the first or second possibility may instead of an inner thread also include a plain inner surface in case the fastener has a self-tapping thread, a bayonet coupling structure or other structure with which a fastener may engage to be secured against pulling out into axial directions.

The adjustment part may include a structure for securing the second object to the first object when the anchoring part is anchored relative to the first object and the adjustment part is secured, for example by the discussed means, to the anchoring part. Such structure may especially include a slot nut.

In embodiments, the anchoring part as a whole is tapered towards the proximal side so that the adjustment part can be placed relative to it in a movement along a movement axis that is not fully parallel with the common axis. This may be desirable if for example the adjustment part is secured to the second object prior to being brought into contact with the anchoring part, and the second object needs to be placed relative to the first object in a pivoting movement.

To this end, the anchoring part may have an anchoring part body and at least one peripheral portion protruding radially from the anchoring part body, which peripheral portion forms the first control surface. The overall taper is then caused by that section of the radially outer surface portion of the anchoring part body that extends proximally of the first control surface being inclined with respect to the axis.

The invention also concerns a method of fastening a second object to a first object that has a sheet portion with an edge, using an adaptor of the discussed kind. In this, the adjustment part may be secured to the second object before being brought together with the anchoring part or thereafter.

In this text, the expression “thermoplastic material being capable of being made flowable e.g. by mechanical vibration” or in short “liquefiable thermoplastic material” or “liquefiable material” or “thermoplastic” is used for describing a material including at least one thermoplastic component, which material becomes liquid (flowable) when heated, in particular when heated through friction i.e. when arranged at one of a pair of surfaces (contact faces) being in contact with each other and vibrationally moved relative to each other. In some situations, for example if the first object itself has to carry substantial loads, it may be advantageous if the material has an elasticity coefficient of more than 0.5 GPa. In other embodiments, the elasticity coefficient may be below this value, as the vibration conducting properties of the first object thermoplastic material do not play a role in the process. In special embodiments, the thermoplastic material therefore may even include a thermoplastic elastomer.

Thermoplastic materials are well-known in the automotive and aviation industry. For the purpose of the method according to the present invention, especially thermoplastic materials known for applications in these industries may be used.

A thermoplastic material suitable for embodiments of the method according to the invention is solid at room temperature (or at a temperature at which the method is carried out). It preferably includes a polymeric phase (especially C, P, S or Si chain based) that transforms from solid into liquid or flowable above a critical temperature range, for example by melting, and re-transforms into a solid material when again cooled below the critical temperature range, for example by crystallization, whereby the viscosity of the solid phase is several orders of magnitude (at least three orders of magnitude) higher than of the liquid phase. The thermoplastic material will generally include a polymeric component that is not cross-linked covalently or cross-linked in a manner that the cross-linking bonds open reversibly upon heating to or above a melting temperature range. The polymer material may further include a filler, e.g. fibres or particles of material which has no thermoplastic properties or has thermoplastic properties including a melting temperature range which is considerably higher than the melting temperature range of the basic polymer.

Specific embodiments of thermoplastic materials are: Polyetherketone (PEEK), polyesters, such as polybutylene terephthalate (PBT) or Polyethylenterephthalat (PET), Polyetherimide, a polyamide, for example Polyamide 12, Polyamide 11, Polyamide 6, or Polyamide 66, Polymethylmethacrylate (PMMA), Polyoxymethylene, or polycarbonateurethane, a polycarbonate or a polyester carbonate, or also an acrylonitrile butadiene styrene (ABS), an Acrylester-Styrol-Acrylnitril (ASA), Styrene-acrylonitrile, polyvinyl chloride, polyethylene, polypropylene, and polystyrene, or copolymers or mixtures of these.

In addition to the thermoplastic polymer, the thermoplastic material may also include a suitable filler, for example reinforcing fibers, such as glass and/or carbon fibers. The fibers may be short fibers. Long fibers or continuous fibers may be used especially for portions of the first and/or of the second object that are not liquefied during the process.

The fiber material (if any) may be any material known for fiber reinforcement, especially carbon, glass, Kevlar, ceramic, e.g. mullite, silicon carbide or silicon nitride, high-strength polyethylene (Dyneema), etc.

Other fillers, not having the shapes of fibers, are also possible, for example powder particles.

Mechanical vibration or oscillation suitable for embodiments of the method according to the invention that include applying mechanical vibration has preferably a frequency between 2 and 200 kHz (even more preferably between 10 and 100 kHz, or between 20 and 40 kHz) and a vibration energy of 0.2 to 20 W per square millimeter of active surface.

In many embodiments that include fastening the anchoring part to a sheet portion having an edge using mechanical vibration, the vibrating tool (e.g. sonotrode) is e.g. designed such that its contact face oscillates predominantly in the direction of the tool axis (the proximodistal axis, corresponding to the axis along which the first object and second objects are moved relative to one another by the effect of the energy input and pressing force when the edge is caused to penetrate into material of the first object; longitudinal vibration) and with an amplitude of between 1 and 100 μm, preferably around 30 to 60 μm. Such preferred vibration is, e.g., produced by ultrasonic devices such as, e.g., known from ultrasonic welding.

Depending on the application, a vibration power (more specifically: the electrical power by which an ultrasonic transducer is powered) may be at least 100 W, at least 200 W, at least 300 W, at least 500 W, at least 1000 W or at least 2000 W.

In this text, the terms “proximal” and “distal” are used to refer to directions and locations, namely “proximal” is the side from which an operator or machine applies the mechanical vibration, whereas distal is the opposite side.

### BRIEF DESCRIPTION OF THE DRAWINGS

In the following, ways to carry out the invention and embodiments are described referring to drawings. In the drawings, same reference numerals refer to same or analogous elements. The drawings show:

FIG. 1 schematically, in vertical section, an arrangement of an anchoring part, a first object and a sonotrode;

FIG. 2 schematically, the anchoring part of FIG. 1 anchored with respect to the first object and assembled with the adjustment part;

FIGS. 3 and 4 views of an embodiment of an adjustment part;

FIGS. 5 and 6 views of an embodiment of an anchoring part for constituting an adaptor together with the adjustment part of FIGS. 3 and 4;

FIG. 7 an assembly of an anchoring part and an adjustment part;

FIG. 8 schematically, an assembly of an alternative adaptor anchored with respect to a first object;

FIGS. 9 and 10 views of a further embodiment of an adjustment part;

FIGS. 11 and 12 views of an embodiment of an anchoring part for constituting an adaptor together with the adjustment part of FIGS. 9 and 10;

FIG. 13 schematically, a further assembly of an alternative adaptor anchored with respect to a first object;

FIGS. 14 and 15 views of an even further embodiment of an adjustment part;

FIGS. 16 and 17 views of an embodiment of an anchoring part for constituting an adaptor together with the adjustment part of FIGS. 14 and 15; and

FIG. 18 an embodiment of an adaptor the anchoring part of which is configured to be attached by an adhesive connection.

### DETAILED DESCRIPTION OF THE INVENTION

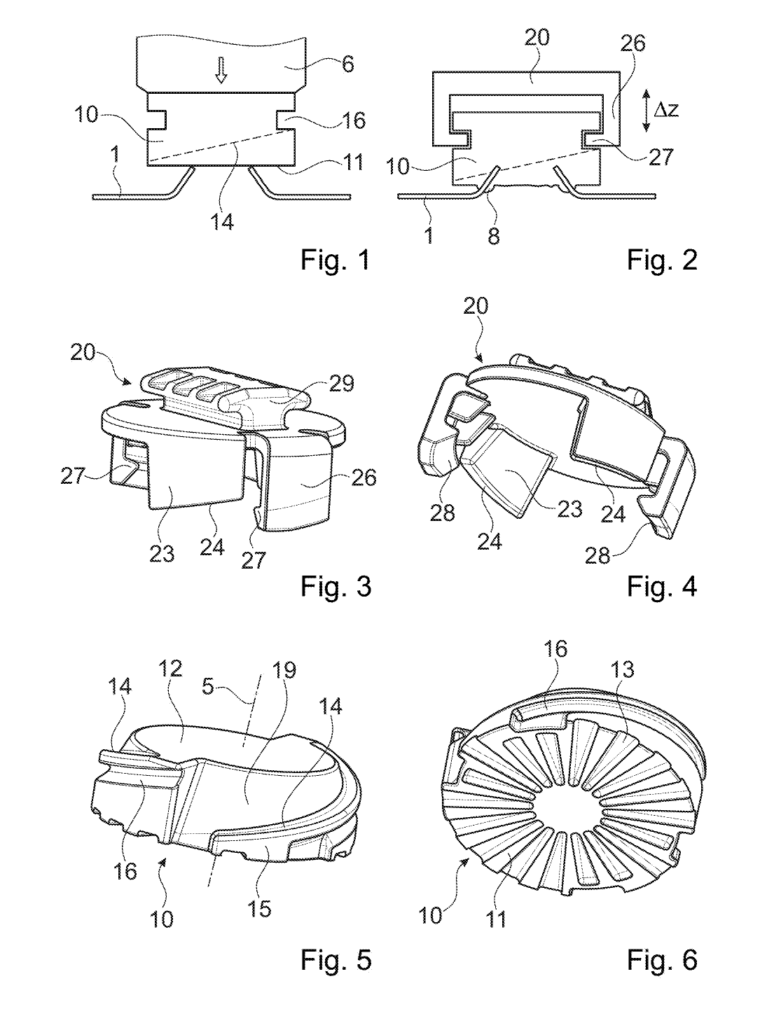

FIG. 1 illustrates, in section, an anchoring part 10 with a metal sheet being an example of a first object 1. The metal sheet includes an opening 20, for example made by a punching tool, and around the opening the metal sheet is deformed to be bent away from a metal sheet plane towards proximally (upwardly in FIG. 1). Around the perforation, the metal sheet forms an edge that in the anchoring step has the function of an energy director.

The anchoring part 10 includes thermoplastic material. In the depicted embodiment, the anchoring part is illustrated to consist of the thermoplastic material. It defines a distally facing anchoring surface 11 that, for anchoring, is brought into contact with the deformed section of the first object 1.

For anchoring the anchoring part 10 with respect to the first object 1, a vibrating sonotrode 6 presses the anchoring part 10 against the first object 1 in a vicinity of the opening. Mechanical vibration energy thereby coupled into the anchoring part 10 propagates via the anchoring part 10 and is absorbed at the places where the anchoring part is in contact with the edge that thereby serves as an energy director. As a consequence, the thermoplastic material around the edge is heated and becomes flowable, allowing the deformed section of the sheet material to be pressed into the body of the anchoring part.

After re-solidification, this leads to an anchoring of the anchoring part with respect to the first object and thereby to a mechanical positive-fit connection between the anchoring part and the second object.

FIG. 2 schematically illustrates the assembly with the first object 1, the anchoring part 10 and an adjustment part 20 after the anchoring process. Parts of a flow portion 8 of the thermoplastic material have flown to underneath the first object and thereby cause the mentioned anchoring.

FIG. 2 illustrates the adjustment part 20 secured to the anchoring part 10 by way of an engagement protrusion 27 engaging in a corresponding indentation 16 of the anchoring part. The adjustment part 20 can be brought into different angular positions relative to the anchoring part with respect to the common axis 5 of the anchoring part and the adjustment part, whereby a z position is adjustable (Δz).

FIGS. 3 and 4 show views of an embodiment of an adjustment part 20.

The adjustment part 20 includes a generally disk-shaped main body. Towards distally, two control surface protrusions 23 project from the main body, each control surface protrusion 23 ending distally in a helical second control surface 24.

Also towards distally, two prongs 26 project from the main body. Each prong 26 has an inwardly projecting engagement protrusion 27. The distal end forms an inward taper 28.

Towards proximally, a slot nut 29 projects from the main body. The slot nut is shaped to engage with a corresponding slot of the second object to secure the second object to the adjustment part and thereby, if the adjustment part is secured to the anchored anchoring part 10, to the first object.

A corresponding anchoring part 10 shaped to cooperate with the adjustment part of FIGS. 3 and 4 is shown in FIGS. 5 and 6. The anchoring part has the mentioned anchoring surface 11 that in the depicted embodiment includes a plurality of radial grooves 13, the function of which is described in PCT/EP2016/073422. An anchoring part body 12 has a slightly conical shape defining a radially outer surface portion 19 that is inclined with respect to the common axis 5. The first control surface 14 is defined by a proximally facing surface portion of a peripheral portion 15 protruding radially from the anchoring part body 12.

The indentation 16 has two portions each distally of a respective portion of the first control surface. The indentation portions run parallel to the first control surface 14 helically around the main body, i.e. the helix angle of the indentation is the same as the helix angle of the first control surface 14. Thereby, the engagement protrusions 27 of the prongs 26 may snap into the indentation 16 when the second control surface 24 abuts against the first control surface 14 independent of the relative orientation.

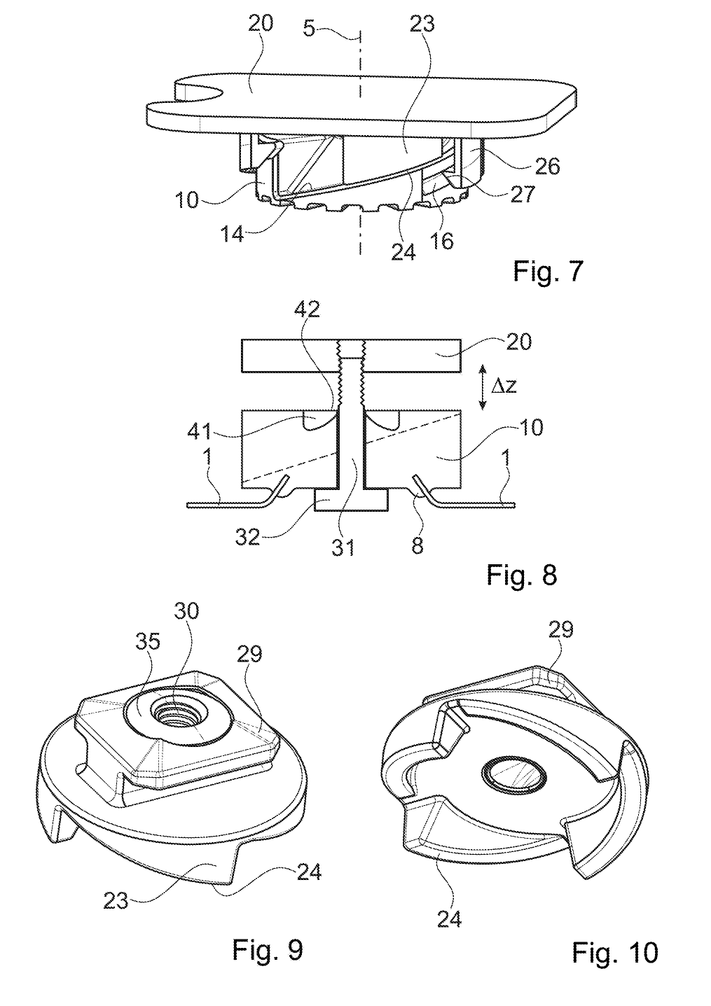

FIG. 7 shows a variant of the adjustment part 20 assembled with a variant of the anchoring part 10.

FIG. 8 shows an alternative assembly after the anchoring process. The adjustment part 20 is secured to the anchoring part 10 (which is anchored with respect to the first object 1) by a screw 31 that presses the second control surface (not visible in FIG. 8) against the first control surface, wherein the relative z position depends on the relative orientation of the adjustment part and the anchoring part.

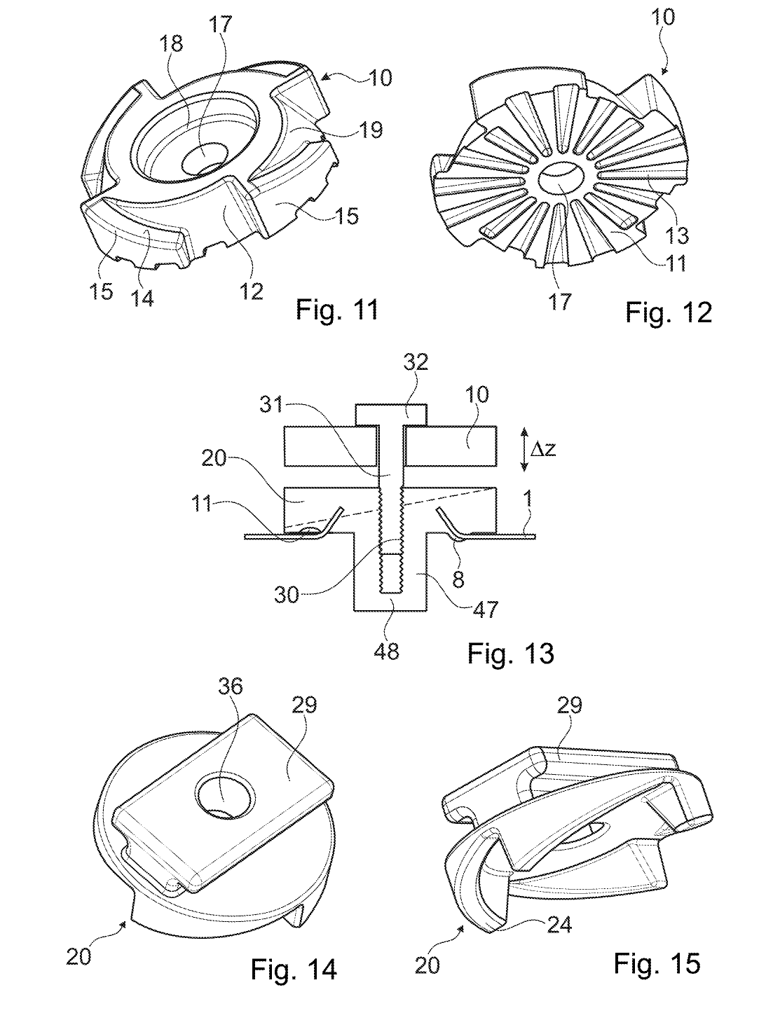

The screw is inserted from distally through a through opening 17 (see FIGS. 11 and 12) of the anchoring part 10 and engages with an inner thread of the adjustment part, whereby a screw head 32 is pressed against a distally facing surface portion of the anchoring part when the screw 31 is tightened.

The anchoring part 10 has a sealing element 41 of an elastically deformable material, for example of an elastomer. The sealing element 41 is fastened to the main body of the anchoring part in a sealing element receiving indentation 18 (see FIG. 11 described hereinafter). The sealing element forms an inwardly projecting sealing lip 42 being pressed against the screw to seal the distal side of the first object 1 from the proximal side.

As an alternative to an initially separate elastically deformable sealing element 41, an elastomeric sealing lip 42 may also be formed by two-component injection molding together with the main body of the anchoring part.

As an even further alternative, a sealing lip 42 may be formed by one-component injection molding, i.e. be of a same material as the main body. This alternative is especially suited for situations in which a liquid pressure against which the sealing lip should seal is small, for example if the sealing is merely to withstand a splash test, for example withstand the pressure of a 50 mm water column for 24 hours.

Yet another alternative is to leave, when manufacturing the anchoring part, a thin membrane closing off the through opening 17, which membrane may be broken through when the screw is placed and seals off thereafter due to the plastic-elastic deformation it undergoes when the screw breaks through it.

FIGS. 9 and 10 show views of an embodiment of an adjustment part suitable for an assembly that implements the principle of FIG. 8. In contrast to the embodiment of FIGS. 3 and 4 it includes a through opening with an inner thread 30. To this end, it may include an adjustment part insert element 35 of a different material than other sections of the adjustment part. Especially, the insert element may for example be of a metal.

FIGS. 11 and 12 show an according anchoring part. The main differences to the embodiment of FIGS. 5 and 6 are the mentioned through opening 17 and the mentioned sealing element receiving indentation 18. Also, the anchoring part does not necessarily have an indentation at the periphery.

FIG. 13 shows an even further assembly after the anchoring process. Like in the embodiment of FIG. 8, the adjustment part 20 is secured to the anchoring part 10 (which is anchored with respect to the first object 1) by a screw 31 that presses the second control surface (not visible in FIG. 13) against the first control surface, wherein the relative z position depends on the relative orientation of the adjustment part and the anchoring part.

The screw is inserted from proximally through an opening 36 (see FIG. 14) of the adjustment part 20 and engages with an inner thread 30 of the anchoring part. The bore in the anchoring part that has the inner thread is closed off towards distally (closed end 48 of extension portion 47), whereby when the connection between the anchoring part and the first object 1 is sealed, whereby a seal between the distal and the proximal sides of the first object is formed.

FIGS. 14 and 15 show views of an according adjustment part 20. A main difference to the embodiment of FIGS. 3 and 4 is the through opening 36.

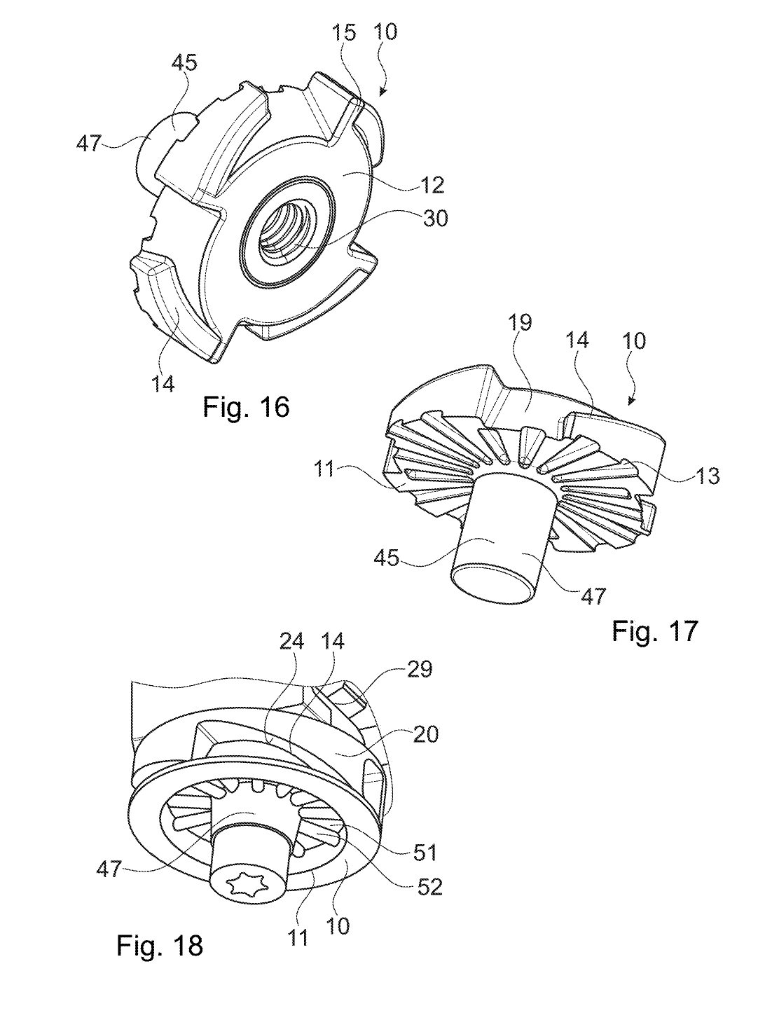

FIGS. 16 and 17 depict view of a suitable anchoring part 10. In contrast to the embodiment of FIGS. 5 and 6 the anchoring part has the extension portion 47 that in the assembled state projects towards distally into the opening of the first object. The bore—being a blind bore in the embodiments illustrated herein—that has the inner thread 30 extends into this extension portion 47; due to the extension portion it has a sufficient depth.

In the embodiment of FIGS. 16 and 17, the extension portion 47 with the inner thread 30 and the closed end 48 is formed by an anchoring part insert element 45 of a material that is different from a main body of the anchoring element, for example metallic.

In the embodiment of FIG. 18, the anchoring surface 11 of the anchoring part is equipped for the anchoring part 10 to be fastened to a first object by an adhesive connection. To this end, the anchoring part at the anchoring surface forms a glue pot 51 for receiving and accommodating a portion of an adhesive (not shown). In the depicted embodiment, the glue pot includes a plurality of radial ribs for ensuring torque stability of the adhesive connection.

The adhesive connection may be combined with a positive-fit connection of the hereinbefore discussed kind, for example in that an anchoring part having the structure shown in FIG. 18 is made of a thermoplastic material.

In the embodiment of FIG. 18, the anchoring part has an optional extension portion 47 through which further parts may be guided, which further parts are not essential for the present invention and are not described in any detail here.

Anchoring of the anchoring part by and adhesive instead of or in addition to a positive fit connection as described hereinbefore may be an option, for example, for revision purposes, i.e. if anchoring of the adaptor loosens after some time and if the person carrying out the revision does not have the equipment for the described fastening process, which equipment may have to include ultrasonic device. At may also serve as an alternative to the fastening process. As yet another alternative, gluing and said fastening process may be used in combination, wherein the fastening process secures a quick anchoring, so that while the adhesive hardens, the assembly including the anchor may already be subject to transport and/or further manufacturing steps.

1. An adaptor for anchoring a second object with respect to a first object, the adaptor comprising:
an anchoring part; and
an adjustment part;
wherein the anchoring part comprises a distally facing anchoring surface and a proximally facing first control surface;
wherein the adjustment part comprises a distally facing second control surface positioned to abut against the first control surface;
wherein the anchoring part and the adjustment part define a common axis, and wherein the first control surface or the second control surface or both is/are helical with respect to the axis, whereby a relative z position of the adjustment part with respect to the anchoring part is adjustable by rotating the adjustment part relative to the anchoring part around the axis while the second control surface abuts against the first control surface;
the adaptor further comprising an engagement structure for fixing the adjustment part relative to the anchoring part with respect to axial directions while the first and second control surfaces abut against each other.

2. The adaptor according to claim 1, wherein the first control surface and the second control surface are both helical with a same helix angle.

3. The adaptor according to claim 1, wherein the anchoring part comprises a solid thermoplastic material liquefiable by mechanical vibration at least on the anchoring surface.

4. The adaptor according to claim 1, wherein the engagement structure comprises a plurality of prongs of the adjustment part, the prongs clasping the anchoring part and having an engagement protrusion engaging with an indentation of the anchoring part.

5. The adaptor according to claim 4, wherein the indentation is helical with respect to the axis.

6. The adaptor according to claim 4, wherein the prongs have an inwardly tapered distal end.

7. The adaptor of claim 1, wherein the engagement structure comprises a first engagement element of the anchoring part and a second engagement element of the adjustment part, and wherein the first engagement element and/or the second engagement element runs helically with respect to the axis.

8. The adaptor according to claim 1, wherein the engagement structure comprises an inner thread of the adjustment part, wherein the anchoring part comprises an axially running through hole, and wherein the engagement structure further comprises a screw shaped to be inserted from the distal side through the through hole and to engage with the inner thread.

9. The adaptor according to claim 8, further comprising a sealing portion having a sealing lip.

10. The adaptor according to claim 9, comprising a sealing element constituting the sealing portion and being shaped to be placed in a sealing element receiving indentation of the anchoring part.

11. The adaptor according to claim 8, wherein the adjustment part comprises a thermoplastic first material and comprises an adjustment part insert element of a material different from the thermoplastic first material, wherein the insert element comprises the inner thread.

12. The adaptor according to claim 1, wherein the engagement structure comprises an inner thread of the anchoring part, wherein the adjustment part comprises an axially running through hole, and wherein the engagement structure further comprises a screw shaped to be inserted from the proximal side through the through hole and to engage with the inner thread.

13. The adaptor according to claim 12, wherein the anchoring part has an extension portion protruding distally from a plane defined by the anchoring surface, wherein the inner thread extends into an interior of the extension portion.

14. The adaptor according to claim 13, wherein the extension portion has a closed distal end, whereby the inner thread extends from a proximal mouth into a blind hole distally closed off by the closed distal end.

15. The adaptor according to claim 1, wherein the anchoring part comprises a thermoplastic first material and comprises an anchoring part insert element of a material different from the thermoplastic first material, wherein the insert element comprises the inner thread.

16. The adaptor according to claim 1, wherein the adjustment part comprises a slot nut for securing a second object to the first object.

17. The adaptor according to claim 1, wherein the anchoring part has an anchoring part body and at least one peripheral portion protruding radially from the anchoring part body, wherein the first control surface is formed by a proximally facing surface portion of the at least one peripheral portion, and wherein a radially outer surface portion of the anchoring part body proximally of the first control surface is inclined with respect to the axis.

18. A method of fastening a second object to a first object in an adjusted position, comprising the steps of
providing the first object comprising a generally flat sheet portion having an edge;
providing an adaptor, the adaptor comprising:
an anchoring part; and
an adjustment part;
wherein the anchoring part comprises a distally facing anchoring surface and a proximally facing first control surface;
wherein the adjustment part comprises a distally facing second control surface positioned to abut against the first control surface;
wherein the anchoring part and the adjustment part define a common axis, and wherein the first control surface or the second control surface or both is/are helical with respect to the axis, whereby a relative z position of the adjustment part with respect to the anchoring part is adjustable by rotating the adjustment part relative to the anchoring part around the axis while the second control surface abuts against the first control surface;
the adaptor further comprising an engagement structure for fixing the adjustment part relative to the anchoring part with respect to axial directions while the first and second control surfaces abut against each other;
positioning the anchoring part relative to the first object to so that the anchoring surface is in physical contact with the edge;
fastening the anchoring surface to the edge;
Positioning the adjustment part relative to the anchoring part in an adjusted orientation with respect to the axis; and
Securing the second object to the adjustment part.

19. The method according to claim 18, wherein the step of fastening the anchoring surface to the edge comprises the sub-steps of:
pressing the anchoring part and the first object against each other and coupling mechanical vibration energy into the first object until a flow portion of thermoplastic material of the anchoring part due to friction heat generated between the edge and the thermoplastic material becomes flowable and flows around the edge to at least partially embed the edge in the thermoplastic material; and
Stopping the mechanical vibration and causing the thermoplastic material to re-solidify, whereby the re-solidified thermoplastic material at least partially embedding the edge anchors the anchoring part with respect to the first object.
